(19) United States
(12) Patent Application Publication
(10) Pub. No.: US 2007/0192417 A1
(43) Pub. Date: Aug. 16, 2007

(54) Client side actualization of an automated information request process

(76) Inventor: William Arthur Kornfeld, Palo Alto, CA (US)

Correspondence Address: PATRICK REILLY, P.O. BOX 7218, SANTA CRUZ, CA, 95061-7218, US

(21) Appl. No.: 11/351,880

(22) Filed: Feb. 10, 2006

(51) Int. Cl. G06F 15/16

(52) U.S. Cl. 709/206

(57) ABSTRACT

An informational technology system and software for selectively seeking and reporting information are provided. A client system (“client”) is bi-directionally communicatively coupled via an electronic communications network to a data warehouse. The client downloads a software comprising an information request process. The client presents to a user of the client a series of questions and potential responses, and a keyboard or other device to select a response to the question. The software directs the client to actualize an information request process, in which the questions that are presented to the user may depend upon the response(s) to the previous question(s): The information provided by the user to the client system is then wholly or selectively inserted in a formatted electronic message by the client system, optionally during or after a completion of an actualization session of the software, and transmitted to the data warehouse via the communications network.

### FIELD OF THE INVENTION

The Present Invention relates to acquiring information via an electronic communications network, e.g., the Internet. More particularly, the Present Invention relates to actualizing an information request process in a client computer and informing another computer via the electronic communications network of at least some of the information generated therefrom.

### BACKGROUND OF THE INVENTION

Applications programs of distributed electronic information processing applications programs tend to be designed to minimize the amount of computational load placed on a client computer system by a host central server or mainframe computer. These prior art methodologies therefore often resulted in software programs that were communications intensive and created delays in interaction between a human operator of a client computer and a server that was requesting information from the operator. These delays may occur between the answering of one question and the asking of the next question because a communication between the client computer and the server is instantiated partly for the purpose of choosing the next question or questions to ask. The prior art places a burden of communication between the actualization of the information request process by the server system and the provision of information by the client system. This burden of communication may degrade the quality of the user experience of the actualization of the information request process, and thereby reduce the effectiveness of application of the information request process in consumer markets or other environments where communication delays are undesirable.

The term “information request process” is defined as a process by which a series of information requests are made, and wherein certain of the specific information requests to be made at any moment may depend in part on the answers given to prior information requests and the logical structure of the information request process.

In addition, prior art information request processes, are used to create profiles of users and other entities. Certain prior art information request processes are implemented by means of a server system submitting questions via the Internet to a client computer system. Responses to these questions solicited from a user, software agent or other entity are then transmitted from the client system to the server system. The server system actualizes the information request process and administers interaction with the client system in accordance with the information request process and in light of the information received from the client system. Expediting the apparent responsiveness of the client in the interactive experience of the human operator can result in a higher rate of both initiation and completion of an information request process.

Many prior art information request processes comprise decision trees wherein the next question asked is always determined by consulting a fixed logical or graphical structure that defines the totality of the logic of the information request process.

There is therefore a long felt need to provide systems and techniques that reduce the burden of electronic communications in the actualization of an information request process by means of a client computer system and an additional informational technology system.

### SUMMARY OF THE INVENTION

The following presents a simplified summary of the invention in order to provide a basic understanding of one or more aspects of the invention. This summary is not an extensive overview of the invention. It is intended to neither identify key or critical elements of the invention, nor to delineate the scope of the present invention. Rather, the sole purpose of this summary is to present some concepts of the invention in a simplified form as a prelude to the more detailed description that is presented hereinafter.

Towards this object and other object that will be made obvious to one of ordinary skill in the art in light of the present disclosure, a first preferred embodiment of the Method of the Present Invention provides a method to actualize an information request process on a client computer system (hereafter “client”) and communicate at least some information related to the information request process via an electronic communications network from the client to one or more additional computer systems. The first preferred embodiment of the Method of the Present Invention provides a query module that (a.) is written in a powerful client-side software language, e.g., Flash, JavaScript, or Java; (b.) may be executed at the client by, or in relation with, a web browser; (c.) may be executed at the client by a web browser contemporaneously with a Dynamic Hyper Text Mark-up Language software instruction set; and (d.) is downloaded to the client. The Method of the Present Invention can enable an actualization of an information request process by means of a powerful client-side software language.

In certain other alternate preferred embodiments of the first preferred embodiment of the Method of the Present Invention (hereafter “first method”) the information request process is performed by a software encoded machine readable instruction module that is at least partially downloaded via the electronic communications network, e.g., the Internet.

In certain alternate preferred embodiments of the Present Invention an information technology network is provided, wherein the information technology network comprises the client, a client software, a data warehouse computer system, a database, and means to communicatively couple the client and the data warehouse computer system. The client software actualizes an information request process in accordance with (a.) instructions included within or associated with the information request process and (b.) information received from a user, software agent or other entity wherein the information is provided or harvested in response to queries generated by the decision tree.

These and other aspects, features and advantages of the present disclosure will become apparent from the following description of exemplary embodiments, which is to be read in connection with the accompanying drawings.

### BRIEF DESCRIPTION OF THE DRAWINGS

The invention of the present application will now be described in more detail with reference to the accompanying drawings, given only by way of example, in which:

FIG. 1 is a schematic representation of an information technology network;

FIG. 2 is business process diagram of a first preferred embodiment of the Method of the Present Invention;

FIG. 3 is an entity diagram of the interaction of the information technology network of FIG. 1 in instantiating a query module in accordance with the business process diagram of FIG. 2;

FIG. 4 is a representation of a software structure, or table, containing information prepared and received in the execution of the query module of FIG. 3.

FIG. 5 is a representation of a session record prepared in the execution of the query module of FIG. 3, and transmitted within the information technology network of FIG. 1 by elements of the information technology network of FIG. 1;

FIG. 6 is an alternate listing L of textual representations of queries as software encoded within the query module instantiated in accordance with an alternate preferred embodiment of the Method of the Present Invention of FIG. 2;

FIG. 7 is a flowchart of a software module used for instantiating an alternate preferred embodiment of the Method of the Present Invention of applying the listing of FIG. 6;

FIG. 8 is a first subroutine of the software module of FIG. 7; and

FIG. 9 is a second subroutine of the software module of FIG. 7.

### DETAILED DESCRIPTION OF A PREFERRED EMBODIMENT

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

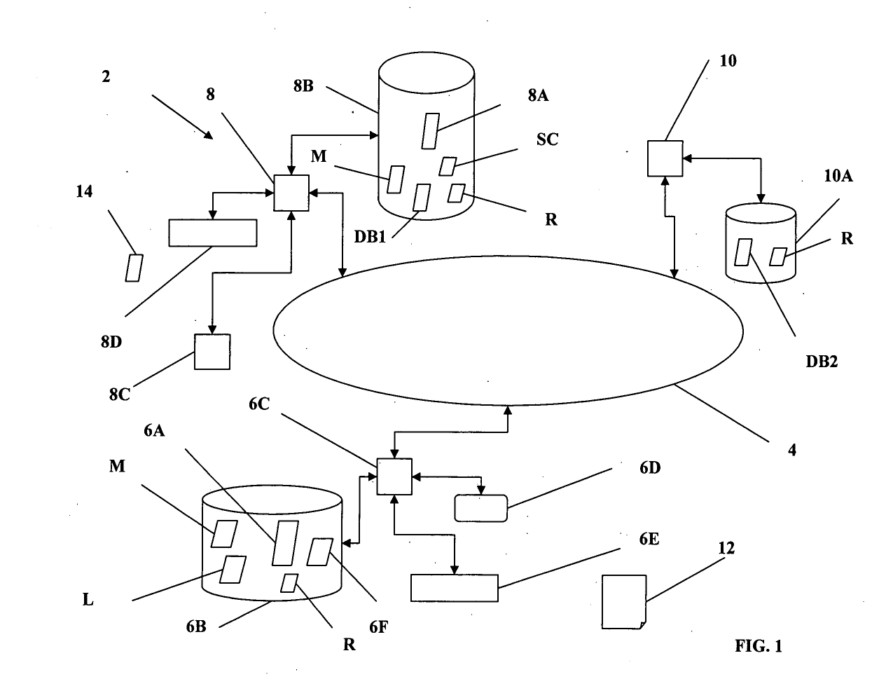

Referring now generally to the Figures and particularly to FIG. 1, FIG. 1 is a schematic representation of an information technology network 2 including an electronic communications network 4, a client 6, a webserver 8, and a storage system 10. The communications network 4 may be or comprise in whole or in part the Internet, an extra-net, and intra-net, a telephony system, a wireless telephony system and/or other suitable electronic communications systems known in the art. The client 6, webserver 8 and storage system 10 are bi-directionally communicatively coupled via the communications network 4. The client 6 may be a personal computer or other computational engine configured to bi-directionally communicatively couple with the Internet by means of a web browser or other suitable communications software known in the art. The webserver 8 stores a website enabling software 8A in a webserver memory 8B, and applies the website enabling software 8A to enable a webpage instantiation by a web browser software 6A (hereafter “web browser 6A”) of the client 6. The webserver 8 may be a personal computer, workstation, mainframe computer, or other computational engine configured to bi-directionally communicatively couple with the Internet by means of a web browser or other suitable communications software known in the art. The web browser 6A is stored in client memory 6B and is at least partially executed by a client controller module 6C. More particularly, the webserver 8 may provide a web page software code SC written in or comprise Dynamic Hyper-Test Mark-up Language (hereafter “DHTML”) to the web browser software 6A wherein the web browser 6A is configured to execute the DHTML software of the software code SC. The client 6 presents a visualization of the website instantiation on a video display device 6D and accepts input from a human operator of the client 6 via one or more input devices 6E. Each input device 6E may be an electronic keyboard, a point and click peripheral, or other suitable human-to-machine information input device known in the art. Alternatively or additionally, one or more input devices 6E may be or comprise a media reader configured to read software encoded instructions stored on a computer-readable media 12, whereby the software encoded instructions when executed by the client 6 will enable and direct the client 6 to actualize an information request process in accordance with information available to the client, and in accordance with an alternate preferred embodiment of the Method of the present Invention. Further more, and still alternatively or additionally, one or more webserver input devices 8C of the webserver 8 may be or comprise a media reader configured to read software encoded instructions stored on a computer-readable media 14, whereby the software encoded instructions, when transmitted to the client 6 via the network 4 and executed by the client 6, will enable and direct the client 6 to actualize an information request process in accordance with information available to the client 6, and in accordance with an alternate preferred embodiment of the Method of the Present Invention.

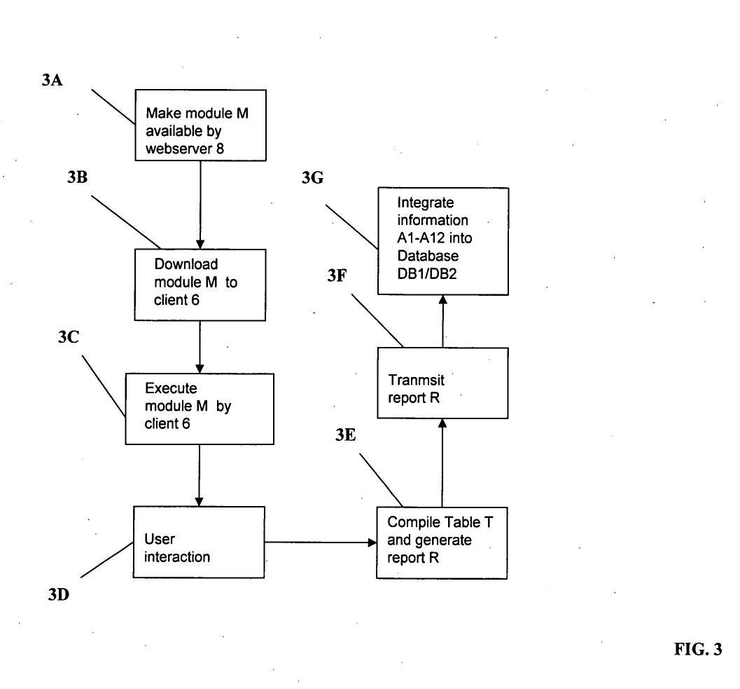

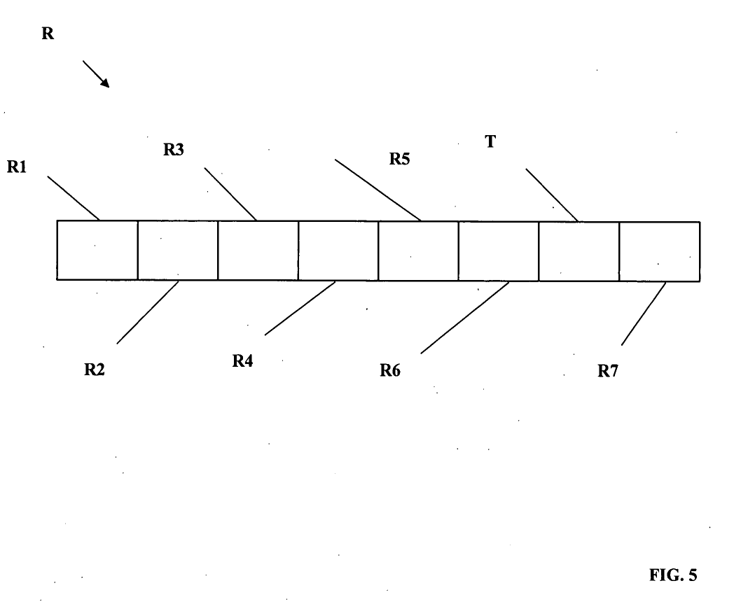

The webserver software 8A further includes and provides a query module M and/or a query module M, comprised within or in addition to the DHTML of the software code 8C, that is also downloaded to the client 6 and instantiated by the web browser 6A. The web browser 6A may comprise enabling software code that compiles or interprets the query module M, e.g., where the query module M is written in Flash, Java, or JavaScript the web browser may comprise a requisite Flash Player, Java execution engine or JavaScript execution engine as required to instantiate the query module M at the client 6. As discussed below generally in reference to the Figures and particularly in reference to FIGS. 3, 4 and 5, the query module M formats responses to queries received by the client 6 from the human operator within a response message R of FIG. 5. The response message R is transmitted by the client 6 via the network 4 (a.) to the webserver 8 and stored in a database DB1 of the webserver 8, and/or (b.) the storage system 10 and stored in a second database DB2 of a storage memory 10A of the storage system 10. A software agent 6F of the client 6 may, in certain yet other alternate preferred embodiments of the Method of the Present Invention, alternatively or additionally provide responses to query module M.

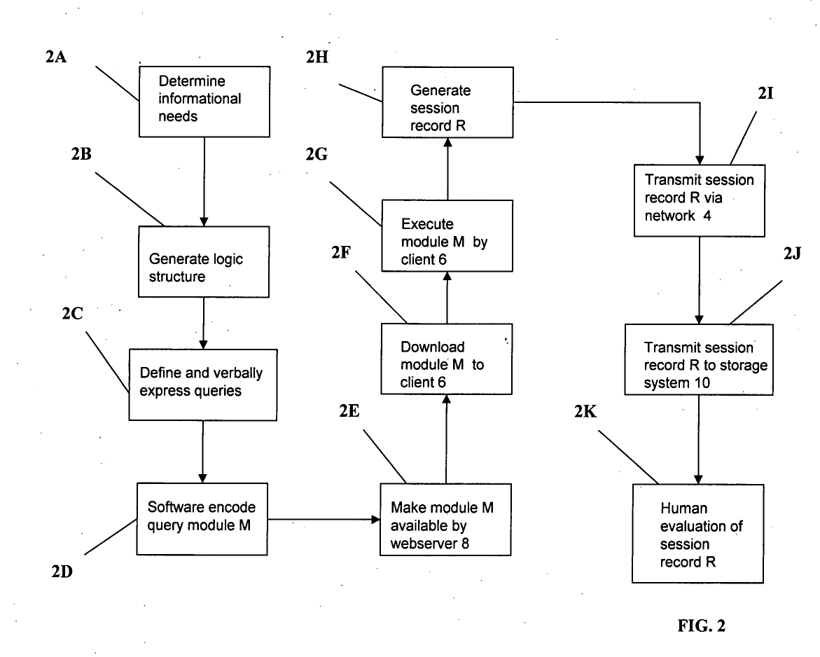

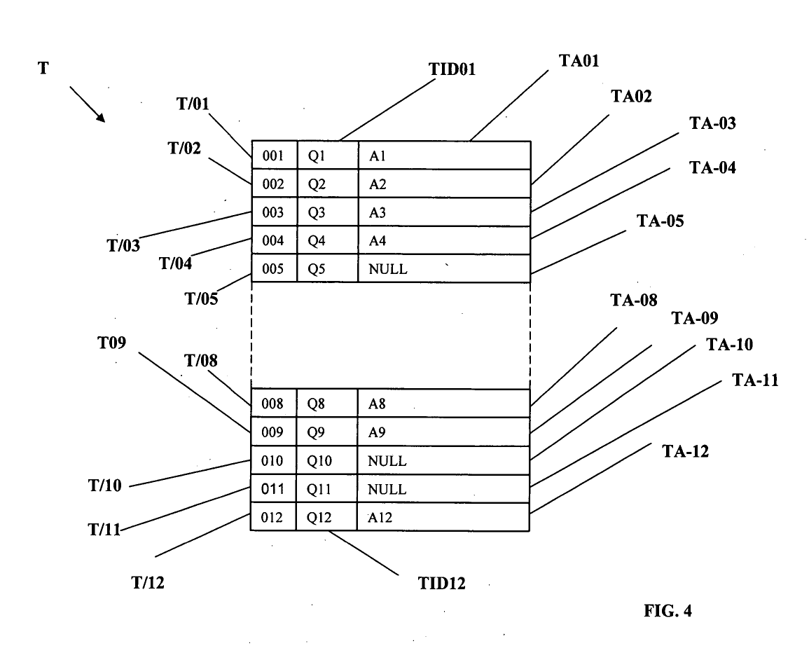

Referring now generally to the Figures and particularly to FIG. 2, FIG. 2 is business process diagram 20 of a first preferred embodiment of the Method of the Present Invention. After gathering informational requirements in step 2A, in step 2B the types of information that might be sought from human operator (hereafter “applicant”) of the client 6 within an anticipated information request process are analyzed to generate a logic structure, wherein information received from the applicant can sometimes determine what additional information is desired thereafter in the instant process. For example, if the applicant is interacting with the query module in pursuit of a mortgage, the logic structure may direct the request for additional types of information depending upon whether the property to be purchased is commercial or residential, or whether the applicant is acting on behalf of himself/herself, a married couple, or a corporation. In step 2C a logic architect defines and verbally expresses the queries that may be relevant in light of the instant loan or financial instrument. In step 2D the architect encodes the query module M that can includes the meaning of each query in a textual representation and enables presentation of the query textual representations in accordance with the query structure diagram. The query module M is made available by the webserver 8 to the client 6 via the network 4 in step 2E. The query module M is downloaded to the client 6 via the network 4 and from the webserver 8 in step 2F. In step 2G the query module M is executed by the client 6 wherein the textual representations are presented to the applicant via the video display 6D in accordance with the query relatedness structure diagram and the query module flowchart of FIG. 4. Information submitted by the applicant in response to the query textual representation presented via the video display 6D are also accepted by the client 6 in step 2G. In step 2H a session record R is prepared. The session record R is transmitted from the client in step 2I from the client to the webserver 8 and/or the storage system 10 in step 2J. In step 2K a human evaluator accesses the session record R to determine whether to continue communication with the applicant and/or transmit information contained in the session record to another party and/or elsewhere within or outside of the information technology network 2.

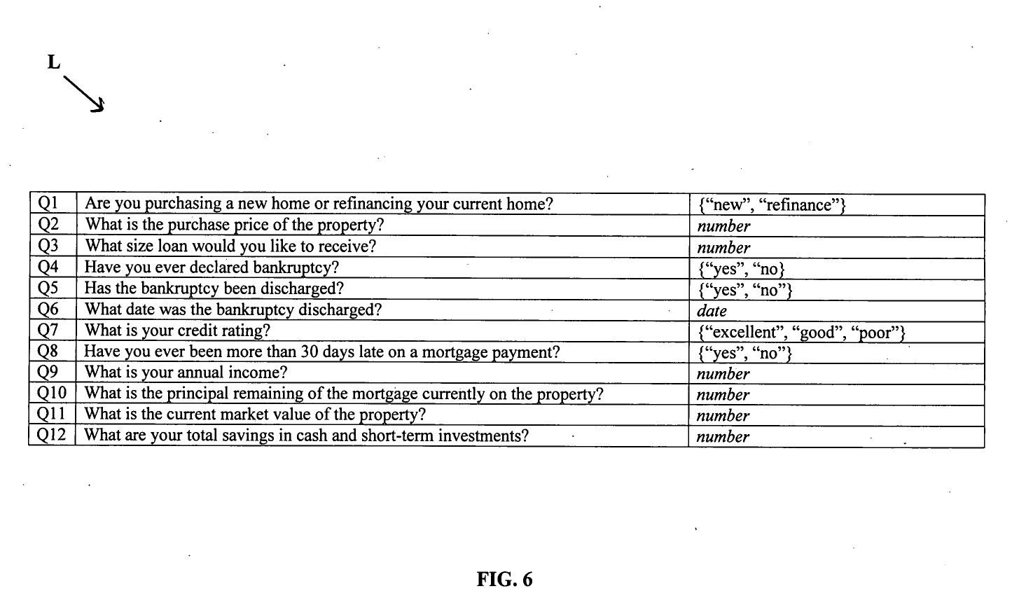

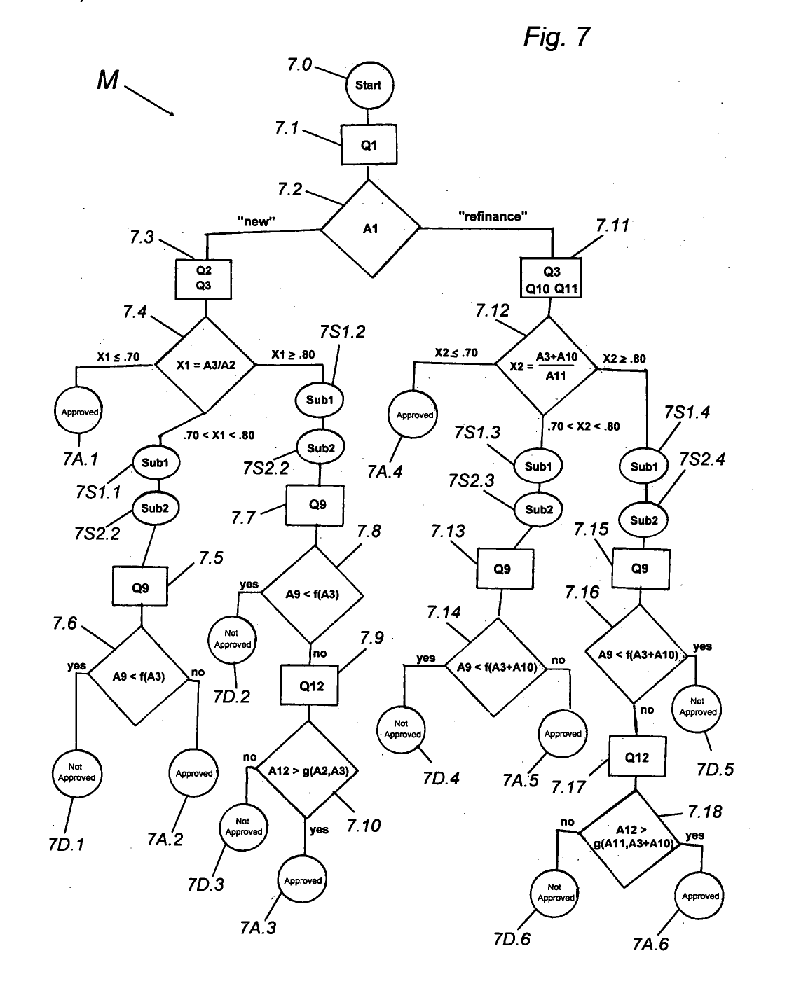

Referring now generally to the Figures and particularly to FIG. 3, FIG. 3 is an illustration of an entity diagram of the webserver 8 and the client 6. In step 3A the software module M, including the query listing L of FIG. 7 is made available by the webserver 8 via the network 4 to the client 6. In step 3B the client 6 downloads the module M and executes module M means of the web browser 6A in step 3C. The module M may be or comprise machine-executable instructions written in, or originated from instructions written in, a suitable software language known in the art, to include DHTML, Java, Javascript, and/or FLASH. The web browser 6A may-employ and comprise a requisite Flash Player, Java execution engine or JavaScript execution engine as required to instantiate the query module M at the client 6. In step 3D the user interacts with the executing query module M and provides replies to the module M by means of communicating responses to presented the queries Q1-Q12 (as per FIG. 7) of the query module. In step 3E the client 6 prepares a report R (as per FIG. 6) that comprise one or more responses provided by the user during step 3D, e.g. at least one response at least one response A1-A12 to the query module M. In step 3F the client 6 communicates the report R to the webserver 8 and/or the storage system 10. In step 3G the webserver 8 and/or the storage system 10 integrates at least one of the information A1-A12 into the respective database DB1 or DB2

Referring now generally to the Figures and particularly to FIG. 4, FIG. 4 is a representation of the table T prepared in the execution of the query module M. Information field identifiers T/01-T/12 uniquely define specific associated pairs of data comprising a query identifier Q1-Q12 and an associated response A1-A12. The queries are identifiers are recorded in query ID fields TID-01-TID-12, and the responses A1-A12 are stored in the response data fields TA-01 through TA-12. It is understood that one or more response data fields TA-01 through TA-12 may contain null values. A null value may be generated when (a.) the associated query Q1-Q12 was not presented to the applicant, (b.) the client 6 did not detect a receipt of a response A1-A12 to a query Q1-Q12, (c.) the client 6 determined to not include a received response in the table T, and/or (d.) the query module M determined to not include a received response in the table T.

Referring now generally to the Figures and particularly to FIG. 5, FIG. 5 is a representation of the session record R prepared in the execution of the query module M by the client 6 and transmitted to the webserver 8 and/or the storage system 10. The session record R includes a network destination address R1, a source destination address R2, a message protocol indicator R3, a message length metric R4, a applicant identifier R5, a date/time stamp R6, the table T of FIG. 4, and a message footer R7. Where the message R is in compliance to transmission communications protocol/internet protocol (hereafter “TCP/IP”), the message R may includes a destination port address associated with a network internet protocol (hereafter, “IP”) destination address R1, a source port address associated with a source IP destination address R2, and an IP protocol indicator R3. The footer R7 and the entire message R may additionally conform to TCP/IP formatting, and the table T may be transmitted in parts from the client distributed within, between or among two or more IP compliant packets.

Referring now generally to the Figures and particularly to FIG. 6, FIG. 6 is a representation of the software encoded listing L of textual representations Q1-Q12 of queries as software encoded within the query module M and for instantiation in accordance with preferred embodiment of the Method of the Present Invention of FIG. 2. The textual representations Q1-Q12 are selected by the client system 6 for presentation to the applicant by means of visual textual representation on the video display 6D and the applicant's replies to the presented queries Q1-Q12 are received by the client system by means of entry by the applicant via the input device 6E.

Referring now generally to the Figures and particularly to FIG. 7, FIG. 7 is a flow chart of the logic process followed by the query module M. In step 7.1 the first query representation Q1 of the alternate listing L2 is presented to the applicant by means of the video display 6D. In step 7.2 the applicant's reply to the first query Q1 is received and analyzed by the client 6. Where the applicant has communicated to the client 6 that the applicant is seeking a new mortgage, the client proceeds onto execute step 7.3, wherein the second query Q2 and the third Q3 are presented to the applicant and replies A2 & A3 as respectively communicated by the applicant in response to the second and third queries Q2 & Q3 are received. In step 7.4 the client determines whether the value X1 resulting from the division of the requested loan amount (as per the third query Q3) divided by the purchase property falls within one of three ranges. Where the X1 value calculated in step 7.4 is determined to be less than or equal to 0.7, the client 6 indicates to the applicant in step 7A.1 that the loan is tentatively approved; where the X1 value calculated in step 7.4 is determined to be greater than 0.7 but less than 0.8, the client 6 proceeds on from step 7.4 on to execute step 7S1.1; and where the X1 value calculated in step 7.4 is determined to be greater than 0.8, the client proceeds on from step 7.4 to step 7S1.2. It is understood that after each loan approval step 7A.1-7A.6 or disapproval step 7D.1-7D.6, the client 6 reports at least one of the information A1-A3 communicated by the applicant in the instantiation of the query module M to the webserver 8 and/or storage system 10 for storage in one or more databases DB1 & DB2.

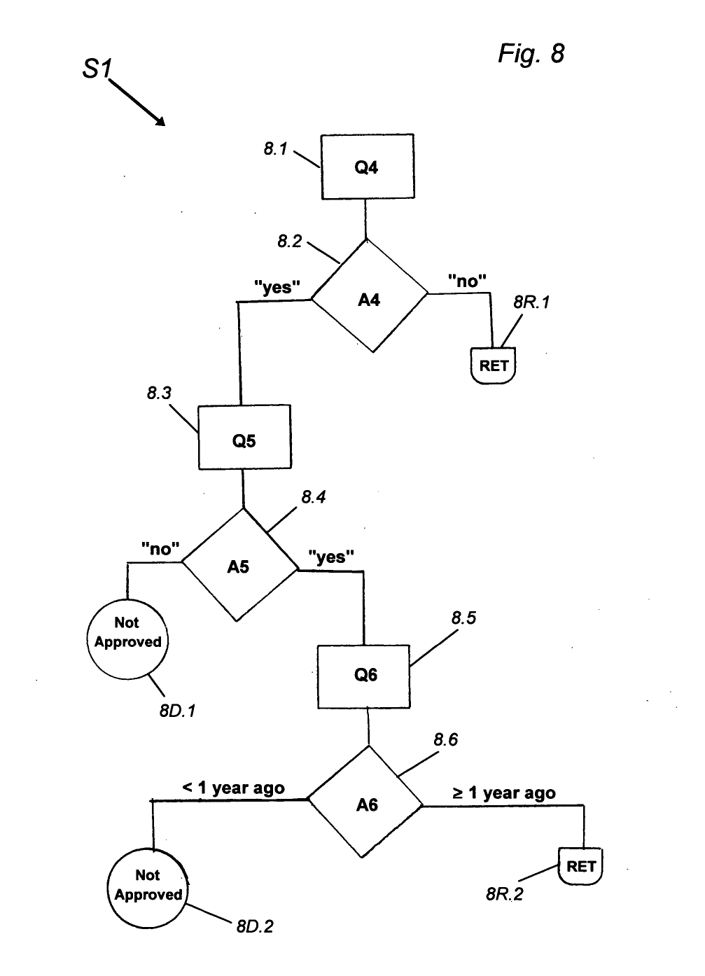

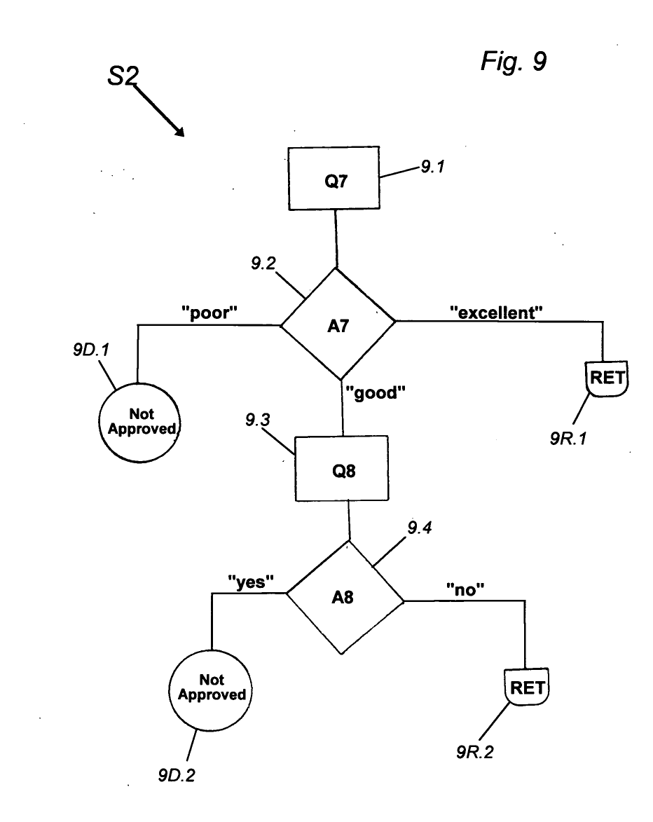

In steps 7S1.1-7S1.4 the client 6 executes the subroutine S1 as diagramed in the subroutine flowchart of FIG. 8. In steps 7S2.1-7S2.4 the client 6 executes the subroutine S2 as diagramed in subroutine flowchart of FIG. 9.

In step 7.5 the client presents the ninth query Q9 and receives a response value A9 from the applicant. In step 7.6 the client 6 determines if the value A9 is less than the value resulting from a resulting value f(A3) of a mathematical function of A3. For example, the function of step 7.6 might be to divide the loan size value A3 (as communicated by the applicant in step 7.3) by a constant, e.g. 6.25, and compare the resulting value of f(A3) to the applicant's reported annual income value of A9 (as communicated in step 7.5). Where f(A3) is determined in step 7.6 to be greater than A9, the client proceeds on from step 7.6 to execute step 7D.1, wherein the applicant is informed by the client 6 that the loan request is tentatively denied, and at least one of the information A1-A9 communicated by the applicant to the client 6 is transmitted to the webserver 8 and the storage system 10 for storage in one or more databases DB1 & DB2. Where f(A3) is determined in step 7.6 to be less than or equal to the communicated income value A9, the client proceeds on from step 7.6 to execute step 7A.2, wherein the applicant is informed by the client 6 that the loan request is tentatively approved and at least one of the information A1-A9 communicated by the applicant to the client 6 is transmitted to the webserver 8 and the storage system 10 for storage in one or more databases DB1 & DB2.

Alternatively, where the X1 value calculated in step 7.4 is determined to be greater than 0.8, the client 6 proceeds from step 7.4 to execute first step 7S1.2 and step 7S2.2, and therefrom in step 7.7 the client 6 presents the ninth query Q9 and receives a response value A9 from the applicant. In step 7.8 the client 6 determines if the value A9 is less than the value resulting from a resulting value f(A3) of a mathematical function of A3. For example, the function of step 7.8 might be to divide the loan size value A3 (as communicated by the applicant in step 7.3) by a constant, e.g. 4.5, and compare the resulting value of f(A3) to applicant's reported annual income value of A9 (as communicated in step 7.7). Where f(A3) is determined in step 7.8 to be greater than the A9 value, the client 6 proceeds on from step 7.8 to execute step 7D.2, wherein the applicant is informed by the client 6 that the loan request is tentatively denied, and at least one of the information A1-A9 communicated by the applicant to the client 6 is transmitted to the webserver 8 and the storage system 10 for storage in one or more databases DB1 & DB2. Where f(A3) is determined in step 7.8 to be less than or equal to the communicated income value A9, the client proceeds on from step 7.8 to execute step 7.9, wherein the twelfth query Q12 is presented to the applicant and the applicant's response is interpreted by the client 6 to be a total savings value of A12. In step 7.10 the client 6 determines if the value A12 received in step 7.9 is less than the value resulting from operation) of a mathematical function f(A2, A3) on the values A2 and A3. For example, the function of step 7.10 might be to subtract the loan size value A3 (as communicated by the applicant in step 7.3) from the purchase price value A2 (also as communicated by the applicant in step 7.3) and compare the resulting value of A2-A3 to the applicant's reported total savings value A12 (as communicated in step 7.9). Where A2 minus A3 is found, in step 7.10, to be less than reported total savings value A12, the client 6 proceeds on from step 7.10 to execute step 7A.3, wherein the applicant is informed by the client 6 that the loan request is tentatively approved and at least one of the information A1-A9 & A12 is communicated by the applicant to the client 6 is also transmitted to the webserver 8 and the storage system 10 for storage in one or more databases DB1 & DB2. Where A2 minus A3 is found, in step 7.10, not to be less than reported total savings value A12, the client 6 proceeds on from step 7.10 to execute step 7D.3, wherein the applicant is informed by the client 6 that the loan request is tentatively denied, and at least one of the information A1-A9 & A12 communicated by the applicant to the client 6 is transmitted to the webserver 8 and the storage system 10 for storage in one or more databases DB1 & DB2.

Where the applicant has communicated to the client 6 that the applicant is seeking a refinancing of a mortgage, the client proceeds from step 7.2 to execute step 7.11, wherein the third query Q3, the tenth query Q10 and the eleventh query Q11 are presented to the applicant and replies A3, A10 and A11 as respectively communicated by the applicant to the client 6, by means of one or more the input device(s) 6E, in response to the third query Q3, the tenth query Q10 and the eleventh query Q11. In step 7.12 a value X2 is calculated as being equal to a division of the sum of the A3 value and the A10 value by the A11 value. Where the X2 value calculated in step 7.12 is determined to be less than or equal to 0.7, the client 6 indicates to the applicant in step 7A.4 that the loan is tentatively approved; where the X2 value calculated in step 7.12 is determined to be greater than 0.7 but less than 0.8, the client 6 proceeds on from step 7.12 on to execute step 7S1.3; and where the X2 value calculated in step 7.12 is determined to be greater than 0.8, the client 6 proceeds on from step 7.12 to step 7S1.4. It is understood that in step 7A.4 that the client 6 reports at least one of the values A1-A8, A10 and A11 as communicated by the applicant in the instantiation of the query module M to the webserver 8 and/or storage system 10 for storage in one or more databases DB1 & DB2.

The client 6 proceeds on from step 7S1.3 to execute step 7S2.3, and therefrom to execute step 7.13, wherein the ninth query Q9 is presented to the applicant and the applicant's responsive communication to the ninth query Q9 is interpreted by the client 6 as being an annual income value A9. In step 7.14 the client 6 compares the A9 value against a value resulting from the operation of a mathematical function on the A3 and A10 values. When A9 is less than the value resulting from the operation of the mathematical function of step 7.14 on the A3 and A10 values, the client 6 proceeds on from step 7.14 to execute step 7D.4, wherein the applicant is informed by the client 6 that the loan request is tentatively denied, and at least one of the information A1-A11 communicated by the applicant to the client 6 is transmitted to the webserver 8 and the storage system 10 for storage in one or more databases DB1 & DB2. When A9 is not less than the value resulting from the operation of the mathematical function of step 7.14 on the A3 and A10 values, the client 6 proceeds on from step 7.14 to execute step 7A.5, wherein the applicant is informed by the client 6 that the loan request is tentatively approved, and at least one of the information. A1-A11 communicated by the applicant to the client 6 is transmitted to the webserver 8 and the storage system 10 for storage in one or more databases DB1 & DB2.

Alternatively, when the client 6 proceeds from step 7.12 to execute step 7S1.4, the client 6 therefrom proceeds to execute step 7S2.4, and then to execute step 7.15, wherein the ninth query Q9 is presented to the applicant and the applicant's responsive communication to the ninth query Q9 is interpreted by the client 6 as being an annual income value A9. In step 7.16 the client 6 compares the A9 value against a value resulting from the operation of a mathematical function on the A3 and A10 values. When A9 is less than the value resulting from the operation of the mathematical function of step 7.14 on the A3 and A10 values, the client 6 proceeds on from step 7.16 to execute step 7D.5, wherein the applicant is informed by the client 6 that the loan request is tentatively denied, and at least one of the information A1-A11 communicated by the applicant to the client 6 is transmitted to the webserver 8 and the storage system 10 for storage in one or more databases DB1 & DB2. When A9 is not less than the value resulting from the operation of the mathematical function of step 7.14 on the A3 and A10 values, the client 6 proceeds on from step 7.16 to execute step 7.17. In step 7.17 the applicant is presented with the twelfth query Q12 and the applicant's responsive communication to the twelfth query Q12 is interpreted by the client 6 as being a total savings value A12. In step 7.18 the client 6 compares the A12 value against a value resulting from the operation of a mathematical function on the A3, A10 and A11 values. When the A12 value is greater than the value resulting from the operation of the mathematical function of step 7.17 on the A3, A10 and A11 values, the client 6 proceeds on from step 7.18 to execute step 7A.6, wherein the applicant is informed by the client 6 that the loan request is tentatively approved, and at least one of the information A1-A12 communicated by the applicant to the client 6 is transmitted to the webserver 8 and the storage system 10 for storage in one or more databases DB1 & DB2. When the A12 value is not greater than the value resulting from the operation of the mathematical function of step 7.18 on the A3, A10 and A11 values, the client 6 proceeds on from step 7.18 to execute step 7D.6, wherein the applicant is informed by the client 6 that the loan request is tentatively denied, and the information A1-A12 communicated by the applicant to the client 6 is transmitted to the webserver 8 and the storage system 10 for storage in one or more databases DB1 & DB2.

Referring now generally to the Figures and particularly to FIG. 8, FIG. 8 is a software flow chart of the subroutine S1 that is executed in steps 7S1.1 -7S1.4 in the instantiation of the flow chart of FIG. 7. In step 8.1 the fourth query Q4 is presented to the applicant via the client 6, and in step 8.2 a response communicated to the client 6 via the input device(s) 6E is received by the client 6 and interpreted as being the answer to the bankruptcy declaration information A4. Where the instant A4 information is a “no” value, the client proceeds from step 8.2 to return to the logical flow of FIG. 7 in step 8R.1. Alternatively, where the A4 value received in step 8.1 via one or more input devices 6E is a “yes” value, the client 6 proceeds from step 8.2 to execute step 8.3, wherein the fifth query Q5 is presented to the applicant via the client 6, and in step 8.4 a response communicated to the client 6 via the input device(s) 6E is received by the client 6 and interpreted as being the answer to the bankruptcy discharge information A5. Where the instant A5 information is a “no” value, the client 6 proceeds from step 8.4 to the loan disapproval and notification step 8D.1. Alternatively, where the A5 value received in step 8.3 via one or more input devices 6E is a “yes” value, the client 6 proceeds from step 8.4 to execute step 8.5, wherein the sixth query Q6 is presented to the applicant via the client 6, and in step 8.4 a response communicated to the client 6 via the input device(s) 6E is received by the client 6 and interpreted as being the answer to the bankruptcy discharge date information A6. Where the instant A6 information is a “less than one year” value, the client 6 proceeds from step 8.6 to the loan disapproval and notification step 8D.2. Alternatively, where the A6 value received in step 8.5 via one or more input devices 6E is a “greater to or equal to one year” value, the client 6 proceeds from step 8.6 to return to the logical flow of FIG. 7 in step 8R.2.

It is understood whenever a loan disapproval step 8D.1-8D.2 is executed, the client 6 may report at least one of the information A1-A8, A10 and A11 communicated by the applicant in the instantiation of the query module M to the webserver 8 and/or storage system 10, and in table T of report R, for storage in one or more databases DB1 & DB2.

Referring now generally to the Figures and particularly to FIG. 9, FIG. 9 is a software flow chart of the subroutine S2 that is executed in steps 7S2.1-7S2.4 in the instantiation of the flow chart of FIG. 7. In step 9.1 the seventh query Q7 is presented to the applicant via the client 6, and in step 9.2 a response communicated to the client 6 via the input device(s) 6E is received by the client 6 and interpreted as being the answer to the credit rating information A7. Where the instant A7 information is a “poor” value, the client 6 proceeds from step 9.2 to the loan disapproval and notification step 9D.1. Alternatively, where the A7 value received in step 9.1 via one or more input-devices 6E is an “excellent” value, the client 6 proceeds from step 9.2 to return to the logical flow of FIG. 7 in step 9R.1. Yet still alternatively, where the A7 value received in step 9.1 via one or more input devices 6E is a “good” value, the client 6 proceeds from, step 9.2 to execute step 9.3, wherein the eighth query Q8 is presented to the applicant via the client 6, and in step 9.3 a response communicated to the client 6 via the input device(s) 6E is received by the client 6 and interpreted as being the answer/information A8 to the late payment information question Q8. Where the instant A8 information is a “yes” value, the client 6 proceeds from step 9.4 to the loan disapproval and notification step 9D.2. Alternatively, where the A8 value received in step 9.3 via one or more input devices 6E is a “greater to or equal to one year” value, the client 6 proceeds from step 9.4 to return to the logical flow of FIG. 7 in step 9R.2.

It is understood whenever a loan disapproval step 9D.1-9D.2 is executed, the client 6 may report at least one of the information A1-A8, A10 and A11 communicated by the applicant in the instantiation of the query module M to the webserver 8 and/or storage system 10, and in table T of report R, for storage in one or more databases DB1 & DB2.

Although the illustrative embodiments have been described herein with reference to the accompanying drawings, it is to be understood that the present disclosure is not limited to those precise embodiments, and that various changes and modifications may be effected therein by one of ordinary skill in the pertinent art without departing from the scope or spirit of the present disclosure. Such changes and modifications are included within the scope and spirit of the present disclosure as set forth in the appended claims.

I claim:

1. In an informational technology system comprising a client communicatively coupled with a data storage system, a method for actualizing an information request process, the method comprising:
a. encoding an information request process in machine-readable software encoded instructions,
b. downloading the software encoded instructions to the client,
c. directing the client to actualize the information request process in light of information available to the client, and
d. transmitting at least part of the information to the data storage system.

2. The method of claim 1, further comprising providing the software via an electronic communications network.

3. The method of claim 2, wherein the electronic communications network is the Internet.

4. The method of claim 1, further comprising receiving at least some of the information from a human operator of the client system.

5. The method of claim 1, further comprising receiving at least some of the information from a software agent.

6. The method of claim 1, further comprising presenting queries to a human operator via a visual representation on a visual display of the client.

7. The method of claim 6, further comprising representing at least part of the information request process by means of a web browser.

8. The method of claim 7, further comprising enabling at least an aspect of the actualization of the information request process by means of instructions encoded in JavaScript.

9. The method of claim 7, further comprising enabling at least an aspect of the actualization of the information request process by means of instructions encoded in DHTML.

10. The method of claim 7, further comprising enabling at least an aspect of the actualization of the information request process by means of instructions encoded in Java.

11. The method of claim 7, further comprising enabling at least an aspect of the actualization of the information request process by means of instructions encoded in Flash.

12. The method of claim 1, wherein the information request process comprises a decision tree.

13. The method of claim 1, wherein the information request process is comprised within a financial decision making process.

14. The method of claim 1, wherein the information request process is comprised with a monetary loan request process.

15. The method of claim 1, wherein the information request process is comprised within a mortgage loan application process.

16. An article of manufacture, comprising a computer-readable media bearing machine-readable software encoded instructions that, when executed by a client, direct the client to actualize an information request process in accordance with information available to the client.

17. The computer-readable media of claim 16, further comprising machine-readable software encoded instructions that, when executed by a client, direct the client to transmit at least some of the information via an electronic communications network.

18. The computer-readable media of claim 16, further comprising machine-readable software encoded instructions that, when executed by a client, direct the client to transmit at least some of the information via the Internet
